(19) United States
(12) Patent Application Publication
(10) Pub. No.: US 2009/0316210 A1
(43) Pub. Date: Dec. 24, 2009

(54) IMAGE FORMING APPARATUS, IMAGE FORMING METHOD AND COMPUTER READABLE MEDIUM

(75) Inventor: Masahiro KATO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/412,083

(22) Filed: Mar. 26, 2009

(30) Foreign Application Priority Data
Jun. 19, 2008 (JP) 2008-160011

(51) Int. Cl. G06K 15/02

(52) U.S. Cl. 358/1.18

(57) ABSTRACT

An image forming apparatus includes: an obtaining unit that obtains data containing graphic information representing a segment; a determining unit that determines whether or not the graphic information representing the segment contained in the obtained data satisfies a condition defined as to at least one of a line kind, a line width and a line color of the segment; a first changing unit that changes, when the determining unit determines that the condition is not satisfied, the graphic information representing the segment contained in the obtained data to satisfy the condition; and an output unit that outputs an image based on data representing a result of the change performed by the first changing unit.

### CROSS-REFERENCE TO RELATED APPLICATIONS

This application is based on and claims priority under 35 USC 119 from Japanese Patent Application No. 2008-160011 filed Jun. 19, 2008.

### BACKGROUND

1. Technical Field

The present invention relates to an image forming apparatus, an image forming method and a computer readable medium.

2. Related Art

In an image forming apparatus such as a printer of the related art, the technique has been developed in order not only to realize a high speed processing and cost reduction but also to realize a high image quality (high resolution and high gradation) of a formed image. In a view point of realizing the high image quality of a formed image, since the related art was developed on condition that the formed image is used by a person, there arise various inconvenience in such a case of reading the formed image and automatically extracting information described in the formed image thus read.

### SUMMARY

According to an aspect of the invention, an image forming apparatus, includes: an obtaining unit that obtains data containing graphic information representing a segment; a determining unit that determines whether or not the graphic information representing the segment contained in the obtained data satisfies a condition defined as to at least one of a line kind, a line width and a line color of the segment; a first changing unit that changes, when the determining unit determines that the condition is not satisfied, the graphic information representing the segment contained in the obtained data to satisfy the condition; and an output unit that outputs an image based on data representing a result of the change performed by the first changing unit.

### BRIEF DESCRIPTION OF THE DRAWINGS

Exemplary embodiment(s) of the present invention will be described in detail based on the following figures, wherein:

FIG. 1 is a functional block diagram showing an image forming apparatus according to an example of the invention;

FIG. 2 is a diagram for explaining an image forming processing according to the example of the invention;

FIGS. 3A and 3B are diagrams for explaining the image forming processing according to the example of the invention;

FIGS. 4A and 4B are diagrams for explaining the image forming processing according to the example of the invention;

FIG. 5 is a diagram for explaining the image forming processing according to the example of the invention;

FIG. 6 is a diagram showing an example of a flow chart of the image forming processing according to the example of the invention; and

FIG. 7 is a diagram showing the hardware configuration of the image forming apparatus according to the example of the invention.

### DETAILED DESCRIPTION

An exemplary embodiment of the invention will be explained with reference to drawings.

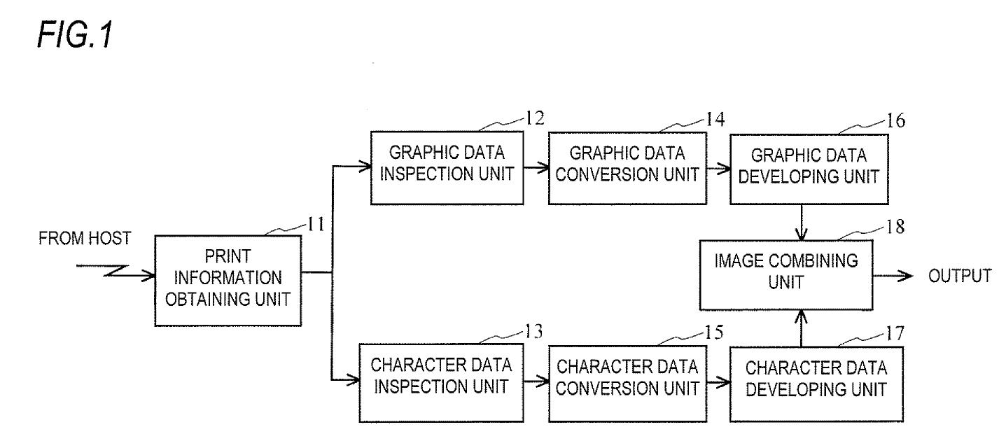

FIG. 1 shows a functional block diagram of an image forming apparatus which develops inputted print information data into image data of a dot format.

The image forming apparatus according to this exemplary embodiment includes a print information obtaining unit 11, a graphic data inspection unit 12, a character data inspection unit 13, a graphic data conversion unit 14, a character data conversion unit 15, a graphic data developing unit 16, a character data developing unit 17 and an image composing unit 18.

The image forming apparatus according to the exemplary embodiment is realized by a virtual printing apparatus (so-called a virtual printer) which performs virtual printing processing based on an electronic document of a format capable of being edited by a user and outputs an electronic document of a format restricting the editing by a user. However, the image forming apparatus may be realized by a printing apparatus or a driver thereof for subjecting a paper medium etc. to a printing processing, for example.

The print information obtaining unit 11 obtains print information data issued from a software such as a document editing application as input data. The input data (print information data) includes at least graphic information and also includes character information in some case.

The graphic data inspection unit 12 inspects the graphic information contained in the input data obtained by the print information obtaining unit 11, and determines whether or not a state of a segment satisfies a condition when the input data contains graphic information representing the segment.

The condition relating to the state of a segment may be a condition representing a state in which the segment can be easily extracted from an image by an ex post facto image analyzing processing such as a front image analysis with respect to an image read by a scanner etc. As an example, the condition is defined such as that allowing only a steady line as the kind of a line (inhibiting a dotted line and a broken line), allowing a line width of 2 pt or more (a line width not erased at the time of reading by a scanner), or allowing only black as a line color (or a density of a value or more).

When the graphic data inspection unit 12 determines that the state of a segment does not satisfy the predetermined condition, the graphic data conversion unit 14 changes the graphic information representing the segment contained in the input data so as to satisfy the condition and also to enlarge a visual difference between the segment and other portion of the graphic information.

The state of changing of a graphic portion other than a segment may be a state not influencing on the extracting processing of a character or a segment in the ex post facto image analyzing processing with respect to an image read by a scanner etc. As an example, in the case where an area surrounded by a segment, the color of the area is changed into a color (for example, white) which can be easily separated from a character or a segment.

The graphic data developing unit 16 subjects the graphic information thus changed to a developing processing and supplies a graphic image obtained by the developing processing to the image composing unit 18.

The character data inspection unit 13 inspects the character information contained in the input data obtained by the print information obtaining unit 11, and determines whether or not a state of a character based on the character information satisfies a condition.

The condition relating to the state of a character may be a condition representing a state in which a visual difference of the character from the background is large and so a character recognition processing etc. using an OCR (Optical Character Reader) can be performed easily. As an example, the condition is defined such as that allowing only the Arial typeface as a font (inhibiting the Times New Roman typeface), allowing a character size of 12 pt or more, or allowing only black as a character color (or a density of a value or more).

When the character data inspection unit 13 determines that the state of a character does not satisfy the condition, the character data conversion unit 15 changes the character information contained in the input data so as to satisfy the condition.

The character data developing unit 17 subjects the character information thus changed to a developing processing and supplies a character image obtained by the developing processing to the image composing unit 18.

The image composing unit 18 combines the graphic image supplied from the graphic data developing unit 16 with the character image supplied from the character data developing unit 17 and outputs an image representing the combined result.

In this exemplary embodiment, an obtaining unit according to the invention is configured by the print information obtaining unit 11, a determining unit according to the invention is configured by the graphic data inspection unit 12, a first changing unit according to the invention is configured by the graphic data conversion unit 14, a second changing unit according to the invention is configured by the character data inspection unit 13 and the character data conversion unit 15, and an output unit according to the invention is configured by the graphic data developing unit 1G, the character data developing unit 17 and the image composing unit 18.

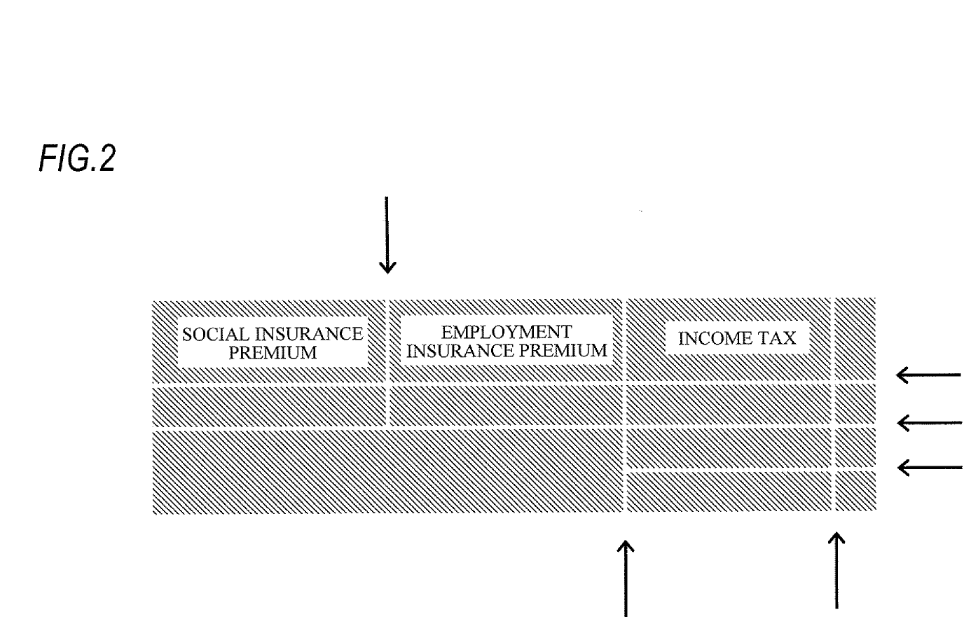

The image forming processing of the image forming apparatus according to the exemplary embodiment will be explained with reference to FIGS. 2 to 5.

The explanation will be made as to a case where the print information obtaining unit 11 obtains, as the input data, print information data which will originally result in a printed state as shown in FIG. 2.

The image in this figure is a document image of a table format which is configured in a manner that the color of ruled lines (portions shown by arrows) forming the table is an achromatic color (white). However, since a pastel color (which is represented as diagonal pattern in the figures) is used as the background color within each column, the configuration of the table can be grasped visually. In the case of using the application dealing with document data itself, the document of such the configuration can be processed without causing any problem even if the ruled lines are black or white. However, in such a processing of analyzing data obtained by imaging the document and extracting the ruled lines, the extraction of white ruled lines requires very complicated processing as compared with that of black ruled lines.

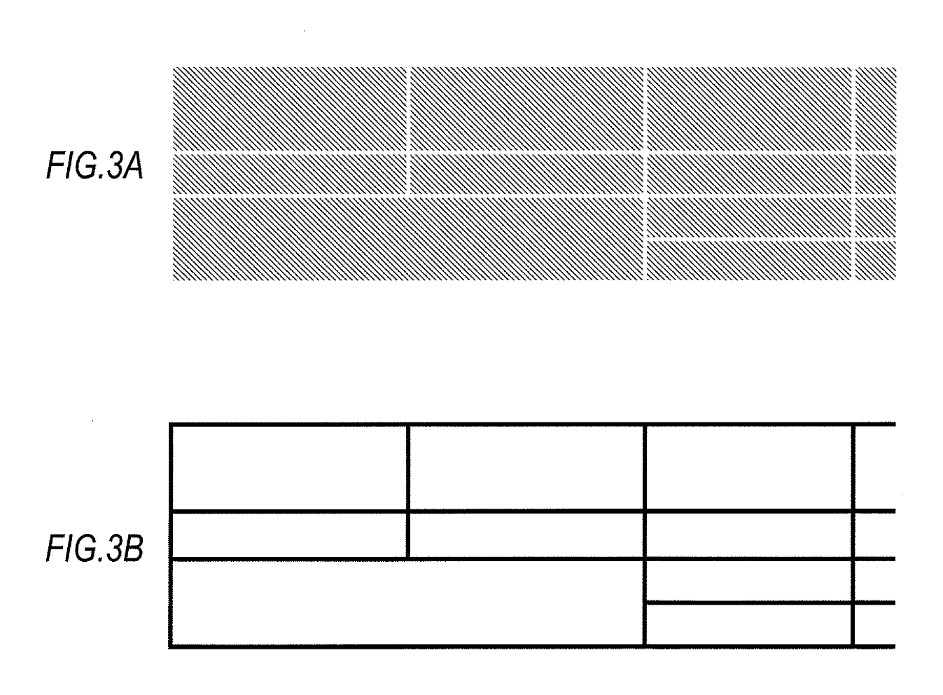

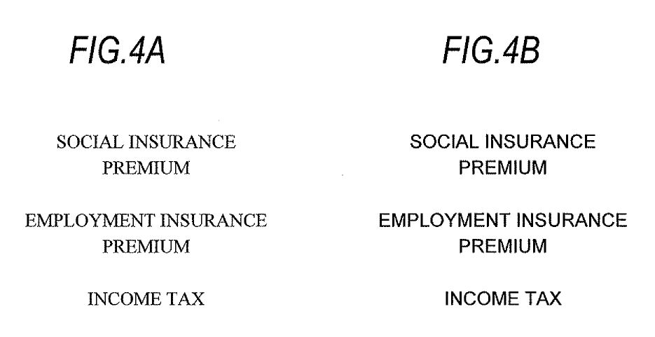

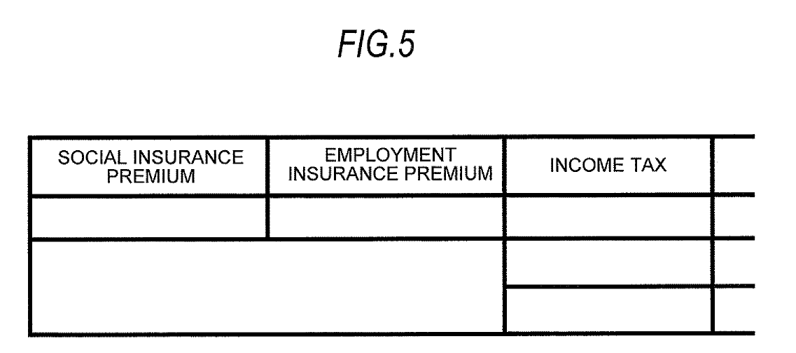

The print information obtaining unit 11 separates the input data representing the image of FIG. 2 into graphic information representing a graphic shown in FIG. 3A and character information representing characters shown in FIG. 4A. The graphic information is transmitted to a processing system for a graphic (the graphic data inspection unit 12, the graphic data conversion unit 14 and the graphic data developing unit 16) and the character information is transmitted to a processing system for characters (the character data inspection unit 13, the character data conversion unit 15 and the character data developing unit 17).

As to the graphic shown in FIG. 3A, since the color of the segments (portions shown by the arrows) constituting ruled lines of the table is white and hence the condition of allowing only black is not satisfied, the graphic information is changed so as to satisfy this condition (changing the color of the ruled lines into black). Further, since the background of the each column of the table is colored, the graphic information is changed so that the color of the background of the each column becomes white. As a result, such an image shown in FIG. 3B can be obtained by developing the graphic information thus changed, whereby the image is placed in a state that the segments in the image can be grasped clearly.

As to the characters shown in FIG. 4B, since the font is Times New Roman typeface and hence the condition of allowing only the Arial typeface is not satisfied, the character information is changed so as to satisfy this condition (changing the font into the Gothic typeface). As a result, such an image shown in FIG. 4B can be obtained by developing the character information thus changed, whereby the image is placed in a state that the characters in the image can be grasped clearly.

FIG. 5 shows an image obtained from the image composing unit 18 by composing the image based on the graphic information thus changed with the image based on the character information thus changed. That is, this image represents a state where the graphic image of FIG. 3B and the character image of FIG. 4B are combined.

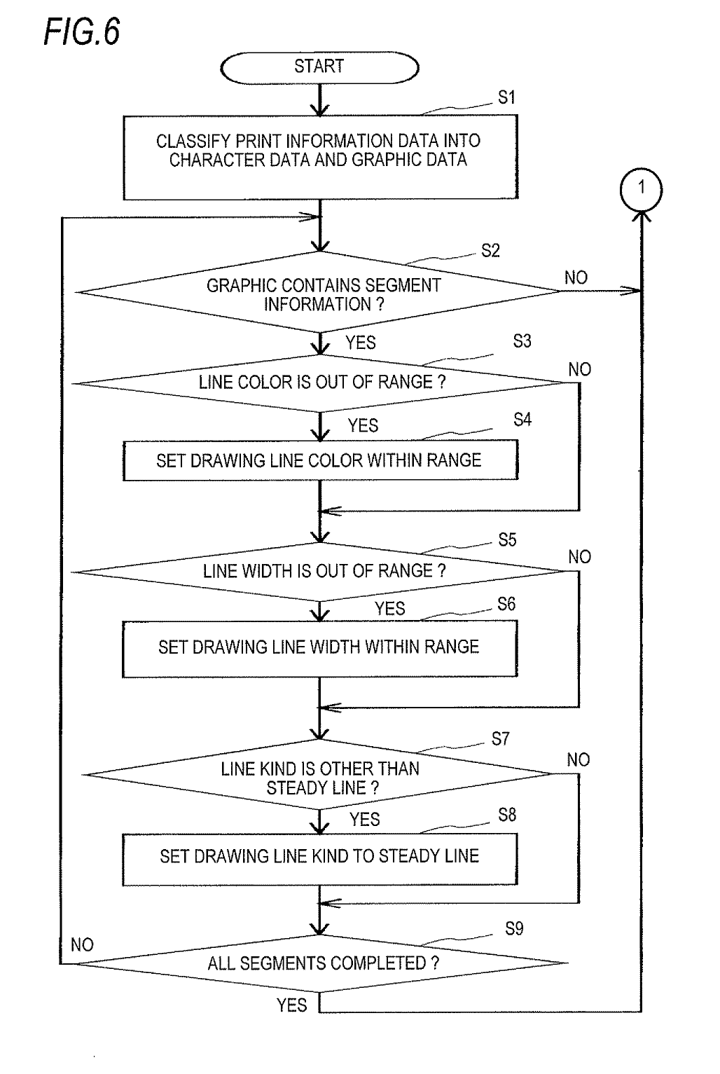

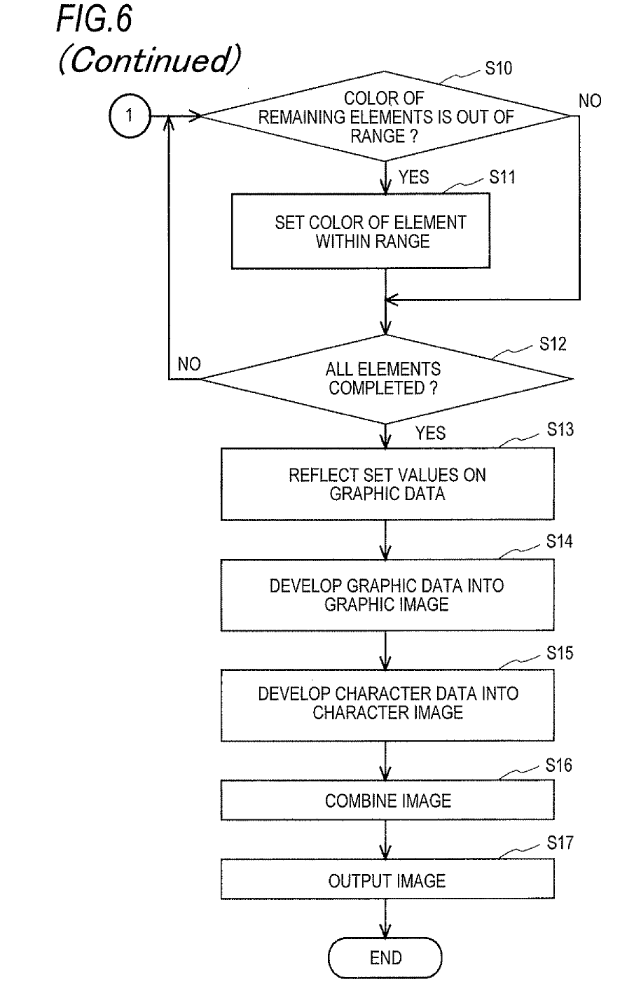

FIG. 6 shows an example of a flowchart showing the image forming processing of the image forming apparatus according to the exemplary embodiment.

When the print information obtaining unit 11 obtains input data (print information data), the contents of the input data is classified into character information and graphic information (step S1).

The graphic information is transmitted to the graphic processing system (the graphic data inspection unit 12, the graphic data conversion unit 14 and the graphic data developing unit 16) and the determination is made whether or not the graphic information contains segment information (step S2). When the segment information is contained, all the segment information is subjected to the determining processing of a line color and the changing processing thereof (steps S3, S4), the determining processing of a line width and the changing processing thereof (steps S5, S6), and the determining processing of the kind of the line and the changing processing thereof (steps S7, S8) (step S9).

When the aforesaid processings are completed as to the information of all the segments contained in the graphic information (or when the graphic information does not contain any segment information), a processing of determining the color of an element (the background color etc. of each column of a table) and the changing processing thereof are performed as to each of all the elements other than the segments of the graphic information (steps S10 to S12). Then, respective setting values relating to the state of the graphic thus changed by the aforesaid processings are reflected on the graphic information (step S13) and the graphic information thus changed is developed into a graphic image (step S14).

The character information is transmitted to the character processing system (the character data inspection unit 13, the character data conversion unit 15 and the character data developing unit 17) and all characters contained in the character information are subjected to the determining processing and the changing processing, whereby respective setting values relating to the state of the graphic thus changed by the aforesaid processings are reflected on the character information and the character information thus changed is developed into a character image (step S15).

Thereafter, the image composing unit 18 combines the graphic image developed by the graphic processing system with the character image developed by the character processing system (step S16) and outputs an image representing the combined result (step S17).

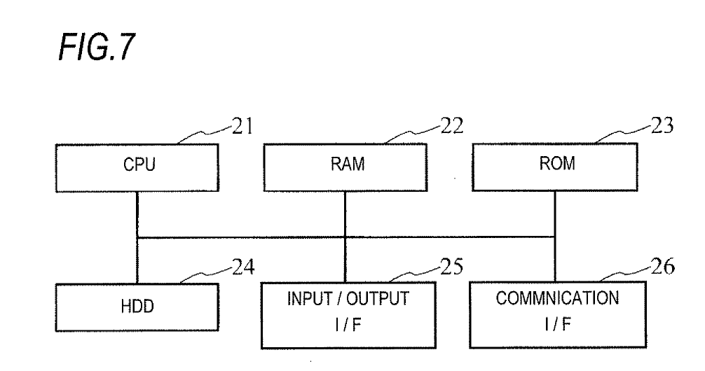

FIG. 7 shows a hardware configuration of portions of the image forming apparatus according to the exemplary embodiment.

The image forming apparatus according to the exemplary embodiment is configured by a computer having hardware resources such as a CPU 21 for performing various kinds of operations, a RAM 22 acting as a work area for the CPU 21, a ROM 23 for storing a basic control program, a HDD 24 which stores programs and various kinds of data for realizing the functions of the invention, an input/output I/F 25 acting as an interface for a display screen for displaying information for a user and for devices such as a mouse or a key board for accepting an input of information from a user, a communication I/F 26 acting as an interface for communicating with other devices.

The programs according to the invention are read from the HDD 24 and developed in the RAM 22 and executed by the CPU 21, whereby the respective functional unit according to the invention is realized by the computer.

The programs according to the invention can be provided to persons implementing the invention by distributing an external storage medium such as a CD-ROM storing the programs or by delivering the programs via a network, for example.

In place of realized by the software configuration like the aforesaid exemplary embodiment, the respective functional units according to the invention may be configured by dedicated hardware modules, respectively.

Further, in place of realizing by the single device like the aforesaid exemplary embodiment, each of the respective functional units according to the invention may be realized a plurality of devices.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus, comprising:
an obtaining unit that obtains data containing graphic information representing a segment;
a determining unit that determines whether or not the graphic information representing the segment contained in the obtained data satisfies a condition defined as to at least one of a line kind, a line width and a line color of the segment;
a first changing unit that changes, when the determining unit determines that the condition is not satisfied, the graphic information representing the segment contained in the obtained data to satisfy the condition; and
an output unit that outputs an image based on data representing a result of the change performed by the first changing unit.

2. The image forming apparatus according to claim 1,
wherein the first changing unit changes, when the determining unit determines that the condition is not satisfied, (i) the graphic information representing the segment contained in the obtained data and also (ii) a portion other than the graphic information representing the segment contained in the obtained data to enlarge visual difference from the segment.

3. The image forming apparatus according to claim 1,
wherein the graphic information contained in the obtained data indicates information representing segments constituting ruled lines of a table.

4. The image forming apparatus according to claim 1,
wherein the obtaining unit obtains data containing character information and the graphic information,
each of the determining unit and the first changing unit performs the graphic information contained in the obtained data, and
the output unit combines the image based on graphic information representing the result of the change performed by the first changing unit with an image based on the character information contained in the obtained data and outputs the combined image.

5. The image forming apparatus according to claim 4, further comprising:
a second changing unit that changes the character information contained in the obtained data to visually enlarge difference between a background and characters based on the character information,
wherein the output unit combines the image based on graphic information representing the result of the change performed by the first changing unit with an image based on the character information representing the result of the change performed by the second changing unit and outputs the combined image.

6. A computer readable medium storing a program causing a computer to execute a process for forming an image, the process comprising:
obtaining data containing graphic information representing a segment;
determining whether or not the graphic information representing the segment contained in the obtained data satisfies a condition defined as to at least one of a line kind, a line width and a line color of the segment;
changing, when determining the condition is not satisfied, the graphic information representing the segment contained in the obtained data to satisfy the condition; and
outputting an image based on data representing a result of the change.

7. The image forming method comprising:
obtaining data containing graphic information representing a segment;
determining whether or not the graphic information representing the segment contained in the obtained data satisfies a condition defined as to at least one of a line kind, a line width and a line color of the segment;
changing, when determining the condition is not satisfied, the graphic information representing the segment contained in the obtained data to satisfy the condition; and
outputting an image based on data representing a result of the change.
